(19) United States
(12) Patent Application Publication
(10) Pub. No.: US 2019/0293177 A1
(43) Pub. Date: Sep. 26, 2019

(54) Control Device in a Motor Vehicle for Outputting a Gear-Shift Recommendation

(71) Applicant: Bayerische Motoren Werke Aktiengesellschaft, Muenchen (DE)

(72) Inventor: Arnd GOLLE, Muenchen (DE)

(21) Appl. No.: 16/436,114

(22) Filed: Jun. 10, 2019

Related U.S. Application Data
(63) Continuation of application No. PCT/EP2018/054934, filed on Feb. 28, 2018.

(30) Foreign Application Priority Data
Mar. 8, 2017 (DE) 10 2017 203 798.9

(51) Int. Cl. F16H 63/42; B60Q 9/00

(52) U.S. Cl. CPC F16H 63/42; F16H 2063/426; B60Q 9/00

(57) ABSTRACT

A control device in a motor vehicle outputs a gear-shift recommendation. The control device has an electronic control unit which can be coupled to an acoustic signal output unit. The control device includes a shift recommendation module for determining a current most economical target gear, a comparison module for determining the distance between the currently-selected actual gear and the target gear, and an acoustic output module for activating an acoustic recommendation signal according to the distance between the actual gear and the target gear.

### CROSS REFERENCE TO RELATED APPLICATIONS

This application is a continuation of PCT International Application No. PCT/EP2018/054934, filed Feb. 28, 2018, which claims priority under 35 U.S.C. § 119 from German Patent Application No. 10 2017 203 798.9, filed Mar. 8, 2017, the entire disclosures of which are herein expressly incorporated by reference.

### BACKGROUND AND SUMMARY OF THE INVENTION

The invention relates to a control device in a motor vehicle for outputting a gear-shift recommendation.

An increase in energy efficiency lies at the focus of current motor vehicle development. Attempts are being made, firstly, to design motor vehicles to be intrinsically energy-efficient and, secondly, to permit drivers to energy-efficiently drive motor vehicles or to encourage or stimulate them to perform such driving. The present invention is concerned with the last-named approach.

For a long time, motor vehicles have been known which, in addition to a speed indicator and an engine speed indicator, have a display of the instantaneous fuel consumption.

In addition, vehicles are known in which a gear-shift recommendation is displayed. If a driver follows this gear-shift recommendation, largely dependent on the engine speed, then fuel can be saved.

For example, the subject matter of DE 10 2009 054 235 A1 is based on the idea of informing a driver simply and easily comprehensibly about important aspects of the vehicle energy consumption during the journey, in such a way that the driver is in a position to adapt his driving behavior on the basis of this information. The aim of course is to reduce the energy consumption of the vehicle. In order not to overload a driver in the process, DE 10 2009 054 235 A1 proposes here firstly to determine the current driving mode (or driving state) of the motor vehicle and, on the basis of the determined current driving mode, to indicate to the driver only or preferably the information which is particularly important in this driving mode for the reduction of the current energy consumption. Preferably, depending on the determined driving mode, information which is important for the reduction of the energy consumption in this driving mode is displayed.

In many manual-shift vehicles, a shift point display is in mass production: this gives a discreet optical recommendation to shift, if expedient from a consumption point of view. This information becomes perceptible only through a deliberate glance at the display.

Furthermore, the patent document WO2015139909 A1 discloses a system which informs the driver of hybrid vehicles about a necessary or recommended gear change via acoustic signals. These acoustic signals which, for example, can resemble the engine noise, are always played as soon as the driver uses a gear which does not coincide with the recommendation.

Disadvantage in the case of an optical display: this information becomes perceivable only through a deliberate glance at this display. Therefore, this recommendation can also remain unnoticed over a relatively long time, with the consequence of increased consumption.

Disadvantage in the case of an acoustic display: the signal is always transmitted acoustically in the same form. It is even perceptible when the driver intuitively shifts correctly. This leads to losses in terms of acoustic comfort.

The invention is based on the object of providing a control device for gear-shift recommendation by which the above-described disadvantages are eliminated.

The main subject of the invention is a control device in a motor vehicle for outputting a gear-shift recommendation, comprising an electronic control unit which can be coupled to an acoustic signal output unit and has the following components:
a shift recommendation module for determining a currently most economical target gear,
a comparison module for determining the distance between the current selected actual gear and the target gear, and
an acoustic output module for activating an acoustic recommendation signal depending on the distance between the actual gear and the target gear.

The invention is based on the following considerations.

In vehicles with manual-shift transmissions, the consumption in customer operation depends critically on the gear selection. Shifting intuitively in terms of optimal consumption is, however, not quite so simple: acoustically well encapsulated and low-vibration drives provide little feedback about the current engine speed, engine load and the currently selected gear. It is therefore simply possible for driving uneconomically in too low a gear to happen in a manner unnoticed over relatively long distances.

Therefore, according to the invention, alternatively or additionally to the optical shift point indication, a shift recommendation is produced acoustically via installed loudspeakers. An economical gear selection for the current load requirement is displayed, for example, by a particularly pleasant acoustic. On the other hand, an uneconomical gear selection can be accompanied by a distinctly less pleasant acoustic, but one which is not considered irritating. The precise expression can preferably be configurable: from “off” via “discreet” as far as a “driving school mode” with a clear expression. In addition, an “adaptive mode” can be implemented; the better the economical shift strategy is followed, the more discreetly can the production be carried out; the less the shift recommendation is followed, the more striking will said production become by contrast. A brief deviation from the shift recommendation preferably remains acoustically unobtrusive.

As a result of the improved perception and the therefore more frequent following of the shift recommendation, entirely economical driving is made possible for the driver.

Therefore, the often criticized gap between consumption in the statutory test cycle and achievable customer consumption, depending on the driving profile, can be reduced. Acoustic comfort losses can be prevented.

Other objects, advantages and novel features of the present invention will become apparent from the following detailed description of one or more preferred embodiments when considered in conjunction with the accompanying drawing.

### BRIEF DESCRIPTION OF THE DRAWING

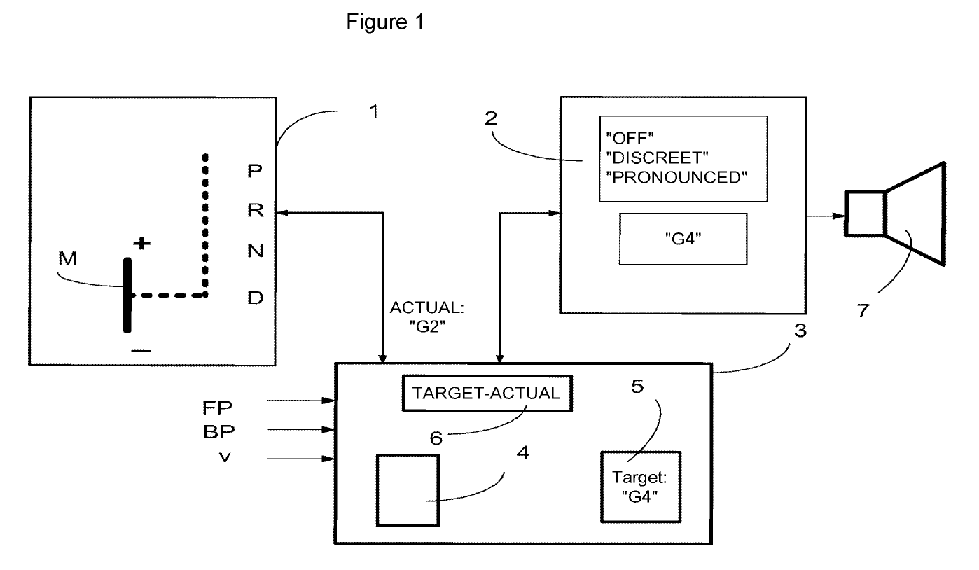

The single FIG. 1 shows, schematically, the components of the invention.

### DETAILED DESCRIPTION OF THE DRAWING

In FIG. 1, a gear selection device 1 is illustrated, which here, for example, shows the activated manual mode M of an automatic transmission. However, the invention can also be used in particular in a manual shift transmission. The control device of a motor vehicle, not specifically illustrated here, comprises an electronic control unit 3, which is at least indirectly coupled to an acoustic signal output unit 7. The electronic control unit 3 is, for example, a conventional transmission control device, which is expanded in accordance with the invention by appropriate programming. The acoustic signal output unit 7 is loudspeakers which are preferably present in any case. In the exemplary embodiment illustrated, the control unit 3 receives the respective current actual gear (e.g. second gear “G2”) from the gear selection device 1. In addition, the control unit 3 is preferably connected to the signal output unit 7 via an input/output unit 2 (e.g. BMW iDrive). According to the invention, the control unit 3 has a shift recommendation module 5 for determining a currently most economical target gear (e.g. fourth gear “G4”), a comparison model 6 for determining the deviation of the currently selected actual gear from the target gear, and an acoustic output model 4 for activating an acoustic recommendation signal via the signal output unit 7, depending on the distance of the actual gear (here, for example, “G2”) from the target gear (here, for example, “G4”).

The most economical gear is determined, for example, depending on the current load requirement, via the gas pedal FP, via the actuation of the brake pedal BP and/or on the vehicle speed v.

By means of the control device according to the invention, the following advanced method according to the invention can be carried out.

By means of appropriate advantageous configuration (in particular programming) of the acoustic output module 5, no signal or a pleasant recommendation signal is activated when the actual gear is equal to the target gear.

Furthermore, by means of appropriate configuration of the acoustic output module 5, with increasing distance of the actual gear from the target gear, an increasingly unpleasant recommendation signal is activated.

By means of appropriate configuration of the acoustic output module 5 and the input/output unit 2, the basic intensity of the recommendation signal can be configured by the driver via the input/output unit 2. For this purpose, the following modes can be indicated and selected: “OFF”, “DISCREET”, “PRONOUNCED”.

Finally, by means of appropriate configuration of the acoustic output module 5, a recommendation signal can be output only when the deviation of the actual gear from the target gear is present for longer than a predefined time period.

In addition, for the acoustic output of a gear-shift recommendation, an optical display (e.g. “G4”) on the input/output unit (2) can be extended.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A control device in a motor vehicle for outputting a gear-shift recommendation, comprising:
an electronic control unit which is coupleable to an acoustic signal output unit, the electronic control unit comprising:
a shift recommendation module that determines a currently most economical target gear,
a comparison module that determines a distance between a current selected actual gear and the target gear; and
an acoustic output module that activates an acoustic recommendation signal via the signal output unit, depending on the distance between the actual gear and the target gear.

2. The control device according to claim 1, wherein
no signal or a first recommendation signal is activatable when the actual gear is equal to the target gear.

3. The control device according to claim 2, wherein
the first recommendation signal is designed to be a pleasant recommendation signal.

4. The control device according to claim 2, wherein
with increasing distance of the actual gear from the target gear, a second recommendation signal is activatable.

5. The control device according to claim 4, wherein
the second recommendation signal is designed to be an increasingly unpleasant recommendation signal.

6. The control device according to claim 1, wherein
an intensity of the recommendation signal is configurable by a driver via an input/output unit.

7. The control device according to claim 1, wherein
the recommendation signal is output only when a deviation of the actual gear from the target gear is present for longer than a predefined time period.

8. A method of outputting a gear-shift recommendation in a motor vehicle, the method comprising the acts of:
Determining, via an electronic control unit, a currently most economical target gear;
Determining, via the control unit, a distance between a current selected actual gear and the currently most economical target gear; and
Activating, via the control unit, an acoustic recommendation signal depending on the distance between the actual gear and the target gear.

9. The method according to claim 8, wherein
no signal or a first recommendation signal is activated when the actual gear is equal to the target gear.

10. The method according to claim 9, wherein
the first signal is designed to be a pleasant recommendation signal for a driver of the motor vehicle.

11. The method according to claim 9, wherein
with an increasing distance of the actual gear from the target gear, a second recommendation signal is activated.

12. The method according to claim 11, wherein
the second recommendation signal is designed to be an increasingly unpleasant recommendation signal for the driver of the motor vehicle.

13. The method according to claim 8, wherein
an intensity of the recommendation signal is configured by a driver via an input/output unit.

14. The method according to claim 8, wherein
the recommendation signal is output only when a deviation of the actual gear from the target gear is present for longer than a predefined time period.
